(19) United States
(12) Patent Application Publication
(10) Pub. No.: US 2026/0065708 A1
(43) Pub. Date: Mar. 5, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Mifu TOTANI, Kawasaki Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/383,971

(22) Filed: Nov. 10, 2025

Related U.S. Application Data
(63) Continuation of application No. PCT/JP2024/043433, filed on Dec. 9, 2024.

(30) Foreign Application Priority Data
Dec. 19, 2023 (JP) 2023-214073

(51) Int. Cl. G06V 40/10; G06F 40/242; G06V 40/18; G10L 15/08

(52) U.S. Cl. CPC G06V 40/103; G06F 40/242; G06V 40/18; G10L 15/083

(57) ABSTRACT

Even when use environment changes, degradation of identification performance is prevented. An information processing apparatus according to an embodiment includes one or more input devices, an extraction unit, a specifying unit, an environment-information-acquisition unit, an analysis unit, and a re-registration unit. The input devices acquire input information. The extraction unit extracts a feature-amount indicating a feature of a person from the input information by using a personal-feature model. The specifying unit specifies the person by comparing the feature-amount with a feature-amount indicated by a person dictionary. The environment-information-acquisition unit acquires environment information from the input information. The analysis unit analyzes a change in the environment information and specifying accuracy of the person by the specifying unit. The re-registration unit performs control to re-register the person dictionary when there is a change in the environment information or when the specifying accuracy is less than an accuracy threshold.

### CROSS-REFERENCE TO RELATED APPLICATIONS

This application is a continuation of International Patent Application No. PCT/JP2024/043433 filed on Dec. 9, 2024 which is based upon and claims the benefit of priority from Japanese Patent Application No. 2023-214073, filed on Dec. 19, 2023; the entire contents of all of which are incorporated herein by reference.

### FIELD

Embodiments described herein relate generally to an information processing apparatus, an information processing method, and a computer program product.

### BACKGROUND

Conventionally, a person identification technology for preventing performance degradation due to a temporal change, a change in physical condition, or the like has been known. For example, there has been conventionally known a method in which, in case of erroneous recognition, the person information is updated by prompting a user to input individual feature information at the time of identification failure.

However, by the conventional technology, it is difficult to prevent degradation in identification performance in a case where use environment changes.

### BRIEF DESCRIPTION OF THE DRAWINGS

FIG. 1 is a diagram illustrating an example of a functional configuration of an information processing apparatus according to a first embodiment;

FIG. 2 is a diagram illustrating an example of a person dictionary storage unit according to the first embodiment;

FIG. 3 is a diagram illustrating an example of an environment information storage unit according to the first embodiment;

FIG. 4 is a flowchart illustrating an example of a person specifying method according to the first embodiment;

FIG. 5 is a diagram illustrating an example of a functional configuration of an environment information acquisition unit according to a first modification of the first embodiment;

FIG. 6 is a diagram illustrating an example of environment information according to the first modification of the first embodiment;

FIG. 7A is a diagram illustrating an example of an acquisition method and a difference calculation method for environment information according to a second modification of the first embodiment;

FIG. 7B is a diagram illustrating the example of the acquisition method and the difference calculation method for the environment information according to the second modification of the first embodiment;

FIG. 8 is a diagram illustrating an example of a functional configuration of an environment information acquisition unit according to the second modification of the first embodiment;

FIG. 9 is a diagram illustrating an example of a functional configuration of an information processing apparatus according to a second embodiment;

FIG. 10 is a diagram illustrating an example of an individual distribution model according to the second embodiment;

FIG. 11 is a diagram illustrating an example of a functional configuration of an environment information acquisition unit according to the second embodiment;

FIG. 12 is a diagram illustrating an example of generating additional input information according to the second embodiment;

FIG. 13 is a flowchart illustrating a first example of a re-registration flow of a person dictionary according to the second embodiment;

FIG. 14 is a flowchart illustrating a second example of the re-registration flow of the person dictionary according to the second embodiment;

FIG. 15 is a diagram illustrating an example of a functional configuration of an information processing apparatus according to a third embodiment;

FIG. 16 is a diagram illustrating an example of a functional configuration of an information processing apparatus according to a fourth embodiment;

FIG. 17 is a diagram illustrating a processing example of a temporal change processing unit according to the fourth embodiment;

FIG. 18 is a diagram illustrating an example of a functional configuration of an information processing apparatus according to a modification of the fourth embodiment; and

FIG. 19 is a diagram illustrating an example of a hardware configuration of the information processing apparatus according to the first to fourth embodiments.

### DETAILED DESCRIPTION

According to an embodiment, an information processing apparatus includes one or more input devices that acquire input information; and one or more hardware processors configured to function as an extraction unit, a specifying unit, an environment information acquisition unit, an analysis unit, and a re-registration unit. The extraction unit extracts a feature amount indicating a feature of a person from the input information by using a personal feature model. The specifying unit specifies the person by comparing the feature amount with a feature amount indicated by a person dictionary. The environment information acquisition unit acquires environment information from the input information. The analysis unit analyzes a change in the environment information and specifying accuracy of the person by the specifying unit. The re-registration unit performs control to re-register the person dictionary in a case where there is a change in the environment information or in a case where the specifying accuracy is less than an accuracy threshold.

Hereinafter, embodiments of an information processing apparatus, an information processing method, and a computer program product will be described in detail with reference to the accompanying drawings. The present disclosure is not limited to the following embodiments.

### First Embodiment

In a first embodiment, an information processing apparatus which, when registering person specifying information, detects a change in environment by also considering environment information such as a noise type and prevents performance degradation by updating the person specifying information according to the environment will be described. The information processing apparatus according to the first embodiment may be any device, and is, for example, a personal computer, a smart device (for example, a tablet, a smartphone, or the like), game machine, or the like.

### Example of Functional Configuration

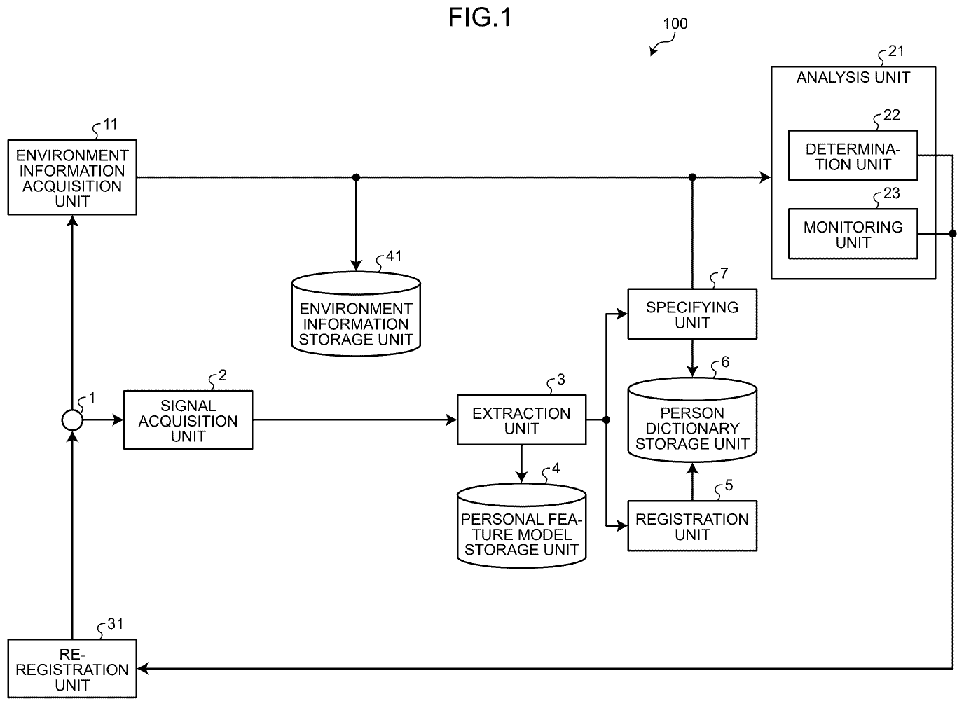

FIG. 1 is a diagram illustrating an example of a functional configuration of an information processing apparatus 100 according to the first embodiment. The information processing apparatus 100 according to the first embodiment includes an input device 1, a signal acquisition unit 2, an extraction unit 3, a personal feature model storage unit 4, a registration unit 5, a person dictionary storage unit 6, a specifying unit 7, an environment information acquisition unit 11, an analysis unit 21, a re-registration unit 31, and an environment information storage unit 41.

The input device 1 is a microphone, a camera, or the like that acquires input information. The input device 1 is not limited to a single unit and may be provided in plurality.

The signal acquisition unit 2 acquires input information from the input device 1.

The extraction unit 3 extracts a personal feature amount from the acquired input information, on the basis of a personal feature model read from the personal feature model storage unit 4. For example, in a case where the input device 1 is a microphone or the like and a signal included in the input information is a voice, the extraction unit 3 performs feature extraction on an acoustic signal input from the microphone at each time. In this case, the extracted feature amount is mel-frequency cepstrum coefficients (MFCC), a mel-filter bank feature amount, or the like.

Furthermore, the extraction unit 3 generates an embedding vector on the basis of the extracted feature amount by i-vector, d-vector (Wan et al., Generalized End-to-End Loss for Speaker Verification, ICASSP 2018, pp. 4879-4883, 2018), x-vector (Synder et al., X-Vectors: Robust DNN Embeddings for Speaker Recognition, ICASSP 2018, pp. 5329-5333, 2018), a derivation method thereof, or the like.

In addition, in a case where the input device 1 is a camera or the like, the extraction unit 3 may extract, as the personal feature amount, the feature amount obtained from an image.

The personal feature model storage unit 4 stores a personal feature model used to extract a feature amount. Specifically, the personal feature model storage unit 4 stores a parameter of the personal feature model for extracting a personal feature.

For example, the registration unit 5 stores, as a person dictionary indicating a personal feature, an average vector of the personal feature amounts of a plurality of frames obtained in a unit time in the person dictionary storage unit 6.

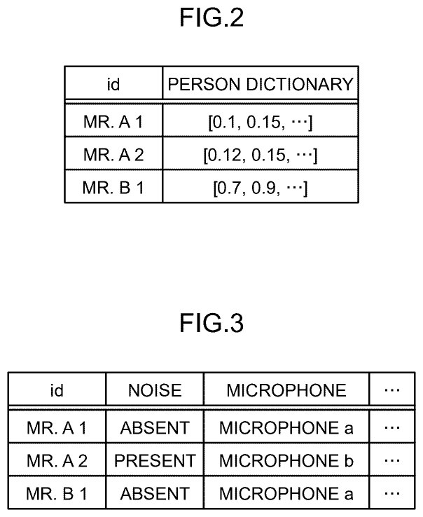

FIG. 2 is a diagram illustrating an example of the person dictionary storage unit 6 according to the first embodiment. The person dictionary storage unit 6 according to the first embodiment includes “id” and the personal feature amount. The “id” is identification information (for example, a unique value) for identifying data of each row. The person dictionary indicates the average vector of the personal feature amounts described above. The example of FIG. 2 is an example of a case where Mr. A is registered at two places and Mr. B is registered at one place. When Mr. A uses the information processing apparatus 100, for example, one may be selected from two person dictionaries of Mr. A according to the location of use of Mr. A. In addition, for example, when the person dictionary is selected, a voice may be uttered by Mr. A, and a person dictionary having the best score (a person dictionary having the highest similarity to Mr. A's voice) may be selected.

Returning to FIG. 1, the specifying unit 7 calculates similarity between the person dictionary stored in the person dictionary storage unit 6 and the personal feature amount extracted from the input signal. A method such as cosine similarity and PLDA (Ioffe, Probabilistic linear discriminant analysis, ECCV, Part IV, LNCS 3954, pp. 531-542, 2006) is used as a similarity calculation method. In a case where there is a person dictionary having similarity exceeding a predetermined threshold, the specifying unit 7 notifies that the person identified by the person dictionary has been specified.

The environment information acquisition unit 11 acquires environment information indicating the environment of the information processing apparatus 100, and stores the acquired environment information in the environment information storage unit 41. Note that details of a method of acquiring the environment information will be described later in a first modification according to the first embodiment.

FIG. 3 is a diagram illustrating an example of the environment information storage unit 41 according to the first embodiment. The environment information storage unit 41 according to the first embodiment includes “id”, “noise”, and “microphone”. The description of “id” is similar to the description of FIG. 2, and thus is omitted. The “noise”, and the “microphone” are examples of the environment information according to the first embodiment. The presence or absence of noise is stored in the “noise”. The type of microphone (for example, identification information or the like for identifying the input device) is stored in the “microphone”.

Returning to FIG. 1, the analysis unit 21 includes a determination unit 22 and a monitoring unit 23. The determination unit 22 determines (detects) an environment change from the environment information acquired by the environment information acquisition unit 11. The monitoring unit 23 monitors the accuracy of the specifying unit 7 (person specifying function).

As examples of the environment change, the presence or absence of noise, a difference in input device, and the like are conceivable. As an accuracy monitoring method, for example, a value obtained by dividing the number of detections of a user registered in the person dictionary storage unit 6 by the total number of detections including the number of detections of other users erroneously identified is used before use of the information processing apparatus 100. For example, in a case where the user is detected 10 times and another user is detected once based on the person dictionary of the user registered in the person dictionary storage unit 6, the accuracy is 10/11.

In addition, for example, as accuracy monitoring of the person specifying function based on speaker identification, a method may be used in which the number of vocalizations of a person, measured by a camera or the like, is compared with the number of detections based on the person dictionary for the person registered in the person dictionary storage unit 6.

In addition, for example, as the accuracy monitoring of the person specifying function by the speaker identification, a method of monitoring that the similarity between the voice of the user and the person dictionary of the user is decreasing may be used.

In addition, for example, as the accuracy monitoring of the person specifying function by the speaker identification, a method of causing the user to feed back the performance of the person specifying function after using the information processing apparatus 100 may be used. As a feedback method, for example, a method may be used in which the user performs evaluation by using the input device 1 such as a touch panel in five stages. In addition, for example, as the feedback method, a method of providing a button notifying that the performance is not excellent, a method of recognizing the facial expression of the user by using the input device 1 such as a camera, or the like may be used.

As a result of the analysis by the analysis unit 21, in a case where the use environment of the user has changed or in a case where the specifying accuracy of the user has become less than a predetermined threshold, the re-registration unit 31 updates the person dictionary of the user. For example, as a method of updating the person dictionary, a method is used which prompts the user to input the input information to the input device 1 again for updating the person dictionary of the person dictionary storage unit 6.

When the person specifying function of the information processing apparatus 100 according to the first embodiment is used, there are two phases: a phase of registering a person dictionary in the person dictionary storage unit 6; and a phase of performing person specification using the registered person dictionary.

The phase of registering the person dictionary in the person dictionary storage unit 6 is performed by the above-described registration unit 5 before using the person specifying function of the information processing apparatus 100.

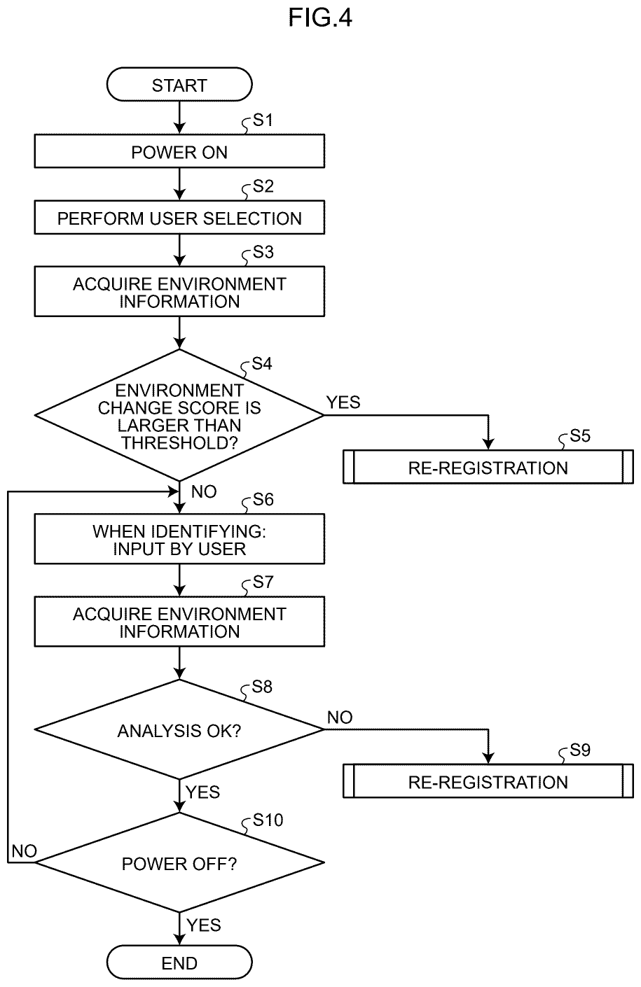

The phase of performing person specification using the registered person dictionary will be described with reference to FIG. 4.

FIG. 4 is a flowchart illustrating an example of a person specifying method according to the first embodiment. First, the information processing apparatus 100 receives a power-on operation input (step S1), and the use of the information processing apparatus 100 is started.

Next, the specifying unit 7 selects a person dictionary to be used for specifying a person (user selection) (step S2). For example, the following methods (i) to (iii) are used for the user selection.
(i) Method of receiving selection operation of registered person dictionary from user via input device 1
(ii) Method of inferring who is using, by assuming a certain user group and narrowing down behavior patterns of user
(iii) Method of inferring using technology of specifying person other than person specification
(i) In the example, for example, in a case where a microphone is provided as one of the input devices 1, candidates of the person dictionary and the description thereof (for example, the description of use environment or the like based on the environment information) are presented on a display device or the like, and selection of the person dictionary is received by voice input from the user. In addition, for example, in a case where a keyboard, a mouse, and the like are provided as one of the input devices 1, selection of the person dictionary is received by an operation input from the user.
(ii) For example, in a case where the information processing apparatus 100 is game machine or the like, the specifying unit 7 specifies the user from login information at the time of logging in to the game machine and selects the person dictionary of the user. In addition, for example, in a case where the information processing apparatus 100 is mounted on an automobile or the like, the specifying unit 7 uses the action pattern (for example, weekday: Mr. A drives, holiday: Mr. B drives, and so on) of the user (driver) as one of determinations of user selection.
(iii) For example, in a case where a camera, a fingerprint authentication sensor, and the like are provided as the input device 1, the specifying unit 7 specifies the user from the captured image, the fingerprint information, and the like, and selects the person dictionary of the user. (iii) For example, in a case where the person specifying function by the specifying unit 7 is speaker identification using voice, the user selection is performed by a function different from the person specifying function, such as image recognition by the camera.

Next, the environment information acquisition unit 11 acquires a part of the environment information (step S3). Next, the determination unit 22 determines an environment change score indicating the magnitude of a difference (the magnitude of the environment change) between the environment information associated with the person dictionary selected in step S2 (the environment information at the time of registering the person dictionary) and the environment information acquired in step S3 (step S4). The presence or absence of the difference is determined as, for example, no difference (the environment change score is less than a threshold) when the same microphone is used, and no difference (the environment change score is less than the threshold) when the same noise type is used. Note that details of the environment change score will be described in the first modification of the first embodiment.

In a case where the environment change score is larger than the threshold (step S4, Yes), the re-registration unit 31 re-registers the person dictionary selected in step S2 (step S5).

In a case where the environment change score is less than the threshold (step S4, No), the specifying unit 7 specifies (identifies) the person by comparing the feature amount extracted from the input by the user with the feature amount indicated by the person dictionary (step S6).

In addition, the environment information acquisition unit 11 acquires the environment information from the input by the user when identifying in step S6 (step S7).

Next, the analysis unit 21 (the determination unit 22 and the monitoring unit 23) analyzes a change in the environment information (a difference between the environment information at the time of registering the person dictionary and the environment information acquired in step S7) and the specifying accuracy of the person by the specifying unit 7 (step S8).

In the case of analysis NG (there is a difference from the environment information at the time of registering the person dictionary, or the specifying accuracy of the person is less than a threshold) (step S8, No), the re-registration unit 31 re-registers the person dictionary selected in step S2 (step S9).

In the case of analysis OK (there is no difference from the environment information at the time of registering the person dictionary, or the specifying accuracy of the person is greater than or equal to the threshold) (step S8, Yes), the processing returns to step S6 unless the information processing apparatus 100 is turned off (no powering off) (step S10, No), and in a case where the information processing apparatus is turned off (powering off) (step S10, Yes), the processing ends.

As described above, in the information processing apparatus 100 according to the first embodiment, one or more of the input devices 1 acquire the input information. The extraction unit 3 extracts a feature amount indicating the personal feature from the input information, by using the personal feature model. The specifying unit 7 specifies a person by comparing the feature amount with the feature amount indicated by the person dictionary. The environment information acquisition unit 11 acquires environment information from the input information. The analysis unit 21 analyzes a change in the environment information and the specifying accuracy of the person by the specifying unit 7. Then, in a case where there is a change in the environment information or in a case where the specifying accuracy is less than the accuracy threshold, the re-registration unit 31 performs control to re-register the person dictionary.

Accordingly, according to the first embodiment, it is possible to prevent the degradation of the identification performance even in a case where the use environment changes. For example, even in a case where the personal feature amount is a feature amount in which noise in the use environment is taken in in addition to the voice of the user, or a feature amount in which a feature other than the feature of the user is also taken into consideration due to the frequency characteristic and signal processing of the microphone being used, it is possible to prevent the degradation of the identification performance.

### First Modification of First Embodiment

Next, a first modification of the first embodiment will be described. In the description of the first modification, the description similar to that of the first embodiment will be omitted, and portions different from those of the first embodiment will be described. In the first modification, a more detailed specific example of the environment information acquisition unit 11 in FIG. 1 and an example of a method of calculating the environment change score will be described.

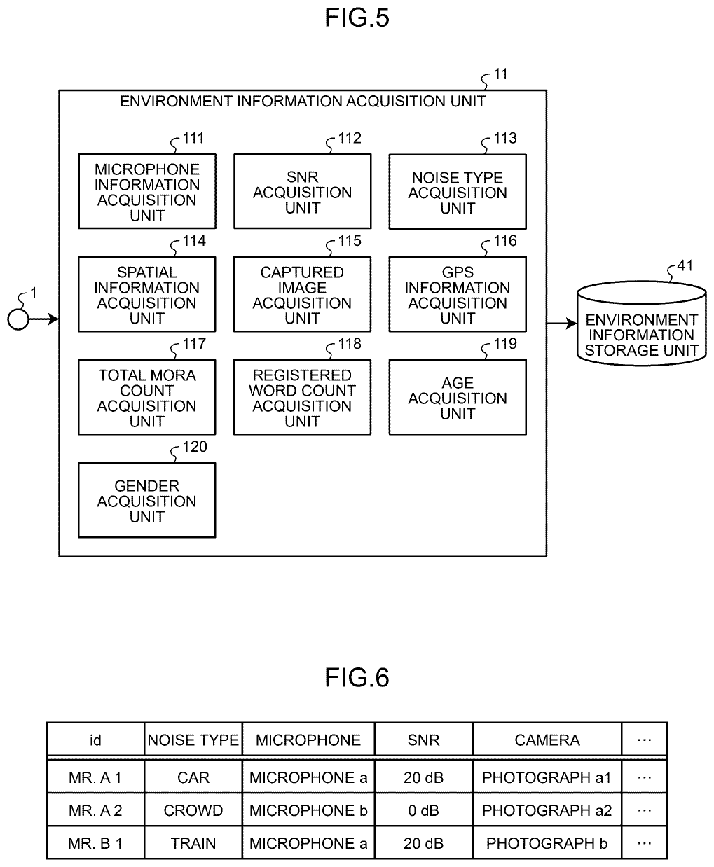

FIG. 5 is a diagram illustrating an example of a functional configuration of the environment information acquisition unit 11 according to the first modification of the first embodiment. The environment information acquisition unit 11 receives inputs of a plurality of pieces of input information from a plurality of input devices 1, and acquires environment information from the plurality of pieces of input information.

For example, the input devices 1 include a microphone, a global positioning system (GPS) receiver that receives input of GPS information, a camera that acquires a captured image, a device (for example, a keyboard and a mouse) that receives an operation input from a user, and the like.

The environment information acquisition unit 11 of the first modification includes a microphone information acquisition unit 111, a signal noise ratio (SNR) acquisition unit 112, a noise type acquisition unit 113, a spatial information acquisition unit 114, a captured image acquisition unit 115, a GPS information acquisition unit 116, a total mora count acquisition unit 117, a registered word count acquisition unit 118, an age acquisition unit 119, and a gender acquisition unit 120.

For example, in a case where the person specifying function is a speaker identification technology, a microphone is used as the input device 1 used for speaker identification. The extraction unit 3 extracts a signal (feature amount) used for person specification, from the acoustic signal acquired from the microphone via the signal acquisition unit 2.

In a method different from that of the signal acquisition unit 2, the microphone information acquisition unit 111, the SNR acquisition unit 112, the noise type acquisition unit 113, and the spatial information acquisition unit 114 each acquire (estimate) environment information, and store the acquired environment information in the environment information storage unit 41.

Specifically, the microphone information acquisition unit 111 acquires the frequency characteristic of the microphone from the input information from the microphone. The SNR acquisition unit 112 acquires the SNR from the input information from the microphone. The noise type acquisition unit 113 acquires the type of noise from the input information from the microphone by using, for example, a classifier capable of classifying noise. The spatial information acquisition unit 114 acquires spatial information (for example, reverberation and reverberation time) of audio from the input information from the microphone.

In addition, the captured image acquisition unit 115 acquires a captured image from the input information from the camera. For example, the captured image is a captured image including a person. In addition, for example, in a case where the camera is an iris sensor, the captured image includes iris information of a person.

The GPS information acquisition unit 116 acquires the position information of the information processing apparatus 100 based on the GPS information, from the input information from the GPS receiver.

In addition, the total mora count acquisition unit 117 acquires a total mora count from the input information input from the microphone at the time of registering the person dictionary. Similarly, the registered word count acquisition unit 118 acquires a registered word count from the input information input from the microphone at the time of registering the person dictionary.

In addition, the age acquisition unit 119 acquires the age of the user via a keyboard, a mouse, and the like. Similarly, the gender acquisition unit 120 acquires the gender of the user via the keyboard, the mouse, and the like.

By acquiring the environment information as described above, it is possible to detect that the environment information is different between when the person dictionary is registered and when the person is specified.

FIG. 6 is a diagram illustrating an example of the environment information according to the first modification of the first embodiment. Since an “id” column is the same as the description of FIG. 2, the description thereof is omitted. In a “noise type” column, for example, a classification result by a classifier capable of classifying noise is stored. A “microphone” column stores an equipment name of the microphone, a frequency characteristic of the microphone, and the like. In an “SNR” column, an average SNR of noise at the time of registering the person dictionary is stored as the magnitude of noise. A captured image is stored in a “camera” column. The other environment information described above is also stored in the environment information storage unit 41 in the same manner hereinafter.

Next, a calculation example of the environment change score will be described. For example, a difference in each environment information is represented by a scalar value, and then scoring is performed based on following Expression (1).

environment change score r=c1*microphone information difference+c2*spatial information difference+c3*SNR difference+ . . . + (1)

Here, c1, c2, c3, . . . are weights, and how to obtain the optimum values of c1, c2, c3, . . . depends on the usage requirement or the like of the information processing apparatus 100. In a case where the environment change score is larger than a threshold (for example, 5(%) or the like), it is determined that the environment has changed, and the re-registration of the person dictionary is performed.

As an example, a method of representing the difference in each environment information by a scalar value has been described. However, the environment change score may be defined by a method using a nonlinear function such as a neural network. An update method (re-registration method) of the person dictionary can be changed according to a combination of the environment change score and the result of the accuracy monitoring of the person specification.

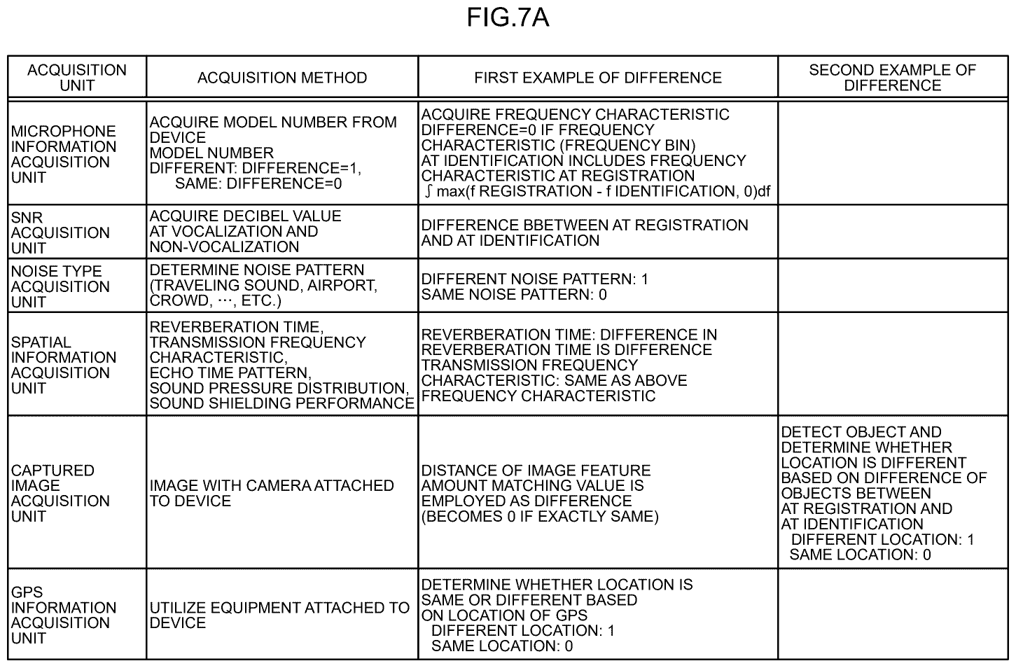

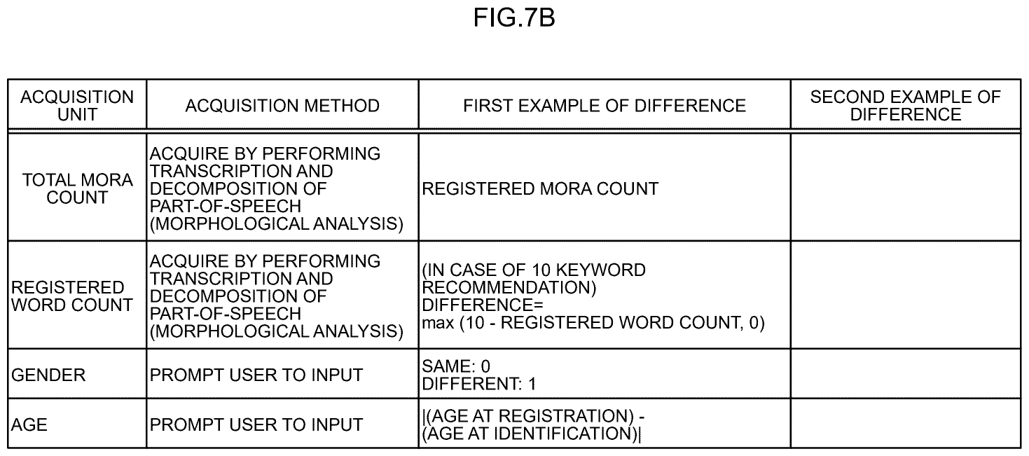

FIGS. 7A and 7B illustrate an example of an acquisition method and a difference calculation method for each environment information in FIG. 2. FIGS. 7A and 7B are diagrams illustrating the example of the acquisition method and the difference calculation method for the environment information according to the first modification of the first embodiment. Note that in the example of FIGS. 7A and 7B, in a case where a plurality of difference calculation methods is conceivable, a second example of the difference is also described.

As illustrated in FIG. 7A, the microphone information acquisition unit 111 acquires the model number (No.) from a device, for which the difference for the different model No. is 1 (difference=1) and the difference for the same model No. is 0 (difference=0). The frequency characteristic is acquired. If the frequency characteristic (frequency bin) at identification includes the frequency characteristic at registration, the difference=0

∫max(fREGISTRATION−fIDENTIFICATION, 0) df in the first example of difference. The SNR acquisition unit 112 acquires decibel values at vocalization and at non-vocalization, for which the decibel value difference between at registration and at identification is calculated as in the first example of difference. The noise type acquisition unit 113 determines the noise pattern (traveling, sound, airport, crowd, etc.). Where, the different noise pattern: 1 and the same noise pattern: 0. The spatial information acquisition unit 114 acquires information by using reverberation time, transmission frequency characteristic, echo time pattern, sound pressure distribution, and sound shielding performance. Where, for the reverberation time, the difference in the reverberation time is employed as the difference. The transmission frequency characteristic is the same as the above-explained frequency characteristic. As the first example of difference for the captured image acquisition unit 115, the distance of the image feature amount matching value is employed as the difference (becomes 0 if exactly the same). As the second example of difference for the captured image acquisition unit 115, the captured image acquisition unit 115 detects an object and determines whether the location is different based on the difference of objects (the object) between at registration and at identification, for which the different location: 1 and the same location: 0. As the first example of difference for the GPS information acquisition unit 116, the GPS information acquisition unit 116 determines whether the location is the same or different based on the location of the GPS, for which the different location: 1 and the same location: 0.

As illustrated in FIG. 7B, the total mora count is acquired by performing transcription and decomposition of the part-of-speech (morphological analysis), for which the registered mora count is listed in the first example of difference. The registered word count is acquired by performing transcription and decomposition of the part-of-speech (morphological analysis). In the case of 10 keyword recommendation, the difference=max(10−the registered word count, 0). For the acquisition of the gender and age, the user is prompted to input. As the first example of difference for the gender, the same: 0 and the different: 0; and as the first example of difference for the age, |(age at registration)−(age at identification)|.

As described above, according to the first modification, it is possible to consider the environment change in consideration of more various types of information in a complex manner.

Note that the example of the environment information acquisition unit 11 in FIG. 5 is an example, and the environment information may be acquired by another method. For example, in a case where a sensor that acquires a fingerprint of a person is provided as the input device 1, information indicating the fingerprint of the person may be acquired as the environment information.

### Second Modification of First Embodiment

Next, a second modification of the first embodiment will be described. In the description of the second modification, the description similar to that of the first embodiment will be omitted, and portions different from those of the first embodiment will be described. In the second modification, a method of inferring a part of data that is not acquirable in a case where a part of the environment information of the environment information acquisition unit 11 in FIG. 1 is not acquirable will be described.

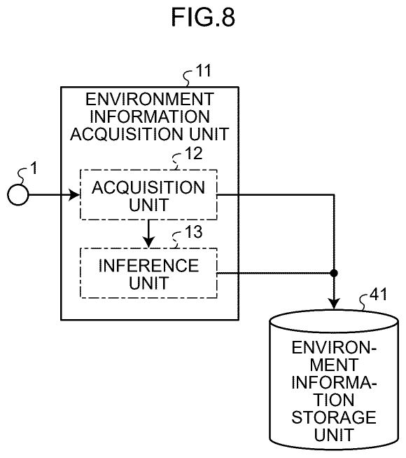

FIG. 8 is a diagram illustrating an example of a functional configuration of the environment information acquisition unit 11 according to the second modification of the first embodiment. The environment information acquisition unit 11 of the second modification includes an acquisition unit 12 and an inference unit 13. The acquisition unit 12 acquires the environment information from the input information input from the input device 1.

The inference unit 13 infers the environment information using, for example, the environment information acquired by the acquisition unit 12 so far and accumulated in the environment information storage unit 41. Accordingly, the environment change can be detected and the person dictionary can be updated with higher accuracy.

For example, with mounted equipment (input device 1) of the information processing apparatus 100, there is a case where noise, spatial information, and the like is not acquirable due to some sort of cause (such as a case where a malfunction makes it unusable). In this case, when a part of data indicating the environment information is not acquirable, the inference unit 13 infers the position information indicated by the part of the data from the position information and the moving speed of the information processing apparatus 100, and infers the environment information indicated by the part of the data that is not acquirable, from the inferred position information. Specifically, the inference unit 13 infers the environment information indicating the type of noise, the spatial information (for example, reverberation and reverberation times), and the like by inferring a current location (for example, in a car, in a crowded city street, at an airport, in a department store, or the like), from the position information, the moving speed, and the like obtained from the GPS information.

In addition, for example, a part of certain continuous time-series data may be missing. In a case where the environment information is time-series data, when a part of the data indicating the environment information is not acquirable, the inference unit 13 infers the environment information by interpolating the part of the data from acquired partial data of the environment information. For example, in a case where data from 2 seconds to 4 seconds cannot be obtained among data of 10 seconds, the inference unit 13 interpolates missing data by performing function approximation with a linear function or the like by using previous and subsequent data. Although a method using a linear function has been described as an example of the interpolation method, a method of approximating a nonlinear function such as a neural network, linear prediction analysis, or the like may be used.

In addition, for example, as an example of the method of inferring the environment information, a method of inferring the environment information by preparing several candidates of versatile environment information and selecting, by the inference unit 13, one of a plurality of candidates of environment information is conceivable.

### Second Embodiment

Next, a second embodiment will be described. In the description of the second embodiment, the description similar to that of the first embodiment will be omitted, and portions different from those of the first embodiment will be described. In the second embodiment, a control of preparing a plurality of re-registration methods (update methods) of the person dictionary and selecting one or more re-registration methods from the plurality of re-registration methods will be described.

### Example of Functional Configuration

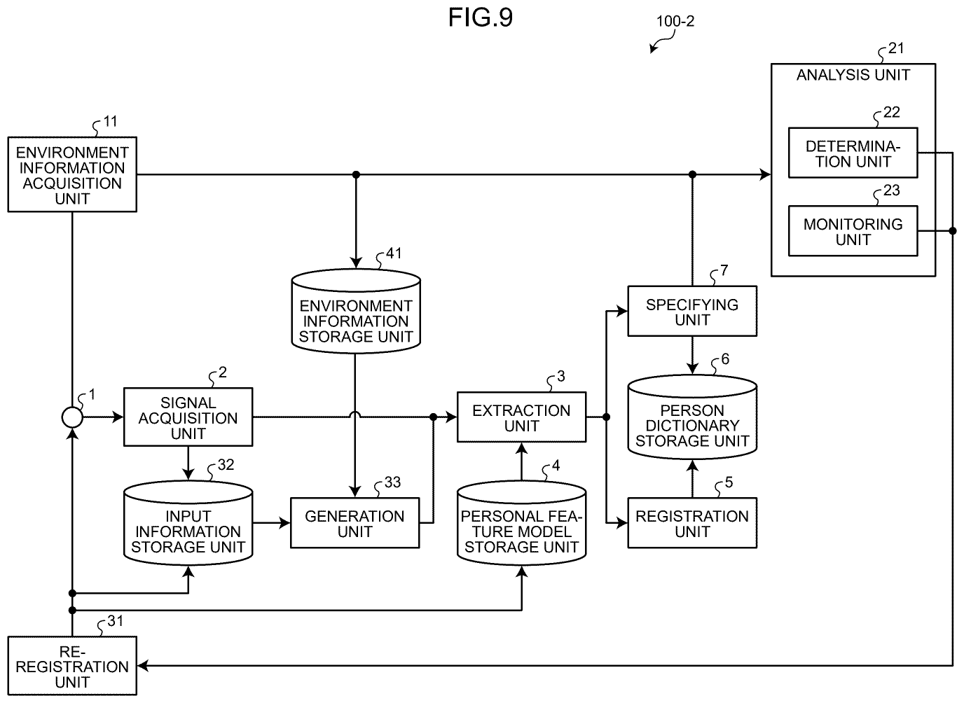

FIG. 9 is a diagram illustrating an example of a functional configuration of an information processing apparatus 100-2 according to the second embodiment. The information processing apparatus 100-2 according to the second embodiment includes the input device 1, the signal acquisition unit 2, the extraction unit 3, the personal feature model storage unit 4, the registration unit 5, the person dictionary storage unit 6, the specifying unit 7, the environment information acquisition unit 11, the analysis unit 21, the re-registration unit 31, an input information storage unit 32, a generation unit 33, and the environment information storage unit 41.

In the second embodiment, the input information storage unit 32 and the generation unit 33 are further added to the configuration of the information processing apparatus 100 according to the first embodiment.

As the re-registration method (update method) of the person dictionary, for example, there are following three methods.

The first is a method of causing the user to input the input information again via the input device 1.

The second is a method in which the re-registration unit 31 requests the generation unit 33 to generate the input information. This is a method in which the generation unit 33 superimposes the environment information of current use environment on the input information indicating the user's voice accumulated in the input information storage unit 32, and re-registers the person dictionary with the superimposed input information. In this method, the re-registration of the person dictionary can be automated without burden on the user. As a method of superimposition, there is a method of synthesizing noise with the user's voice so as to have the current SNR or reproducing reverberation or the like with an acoustic simulator.

For example, in a case where the environment information includes voice recognition environment information obtained from the input information input by the microphone, the second method is used. That is, in a case where the environment change score is larger than the threshold, the generation unit 33 generates update data by superimposing data including the voice recognition environment information on the accumulated input information. Then, the re-registration unit performs control to re-register the person dictionary on the basis of the update data.

Specifically, as the voice recognition environment information, there is a noise type indicating the type of noise, for example. In a case where the environment change score is larger than the threshold, the generation unit 33 generates update data by superimposing data including noise of a noise type corresponding to the current environment on the accumulated input information.

In addition, for example, in a case where, as the voice recognition environment information, the SNR is also obtained in addition to the noise type from the input information, when the environment change score is larger than the threshold, the generation unit 33 generates update data by superimposing, on the accumulated input information, data including noise of the noise type corresponding to the current environment at a ratio corresponding to the SNR.

In addition, for example, in a case where, as the voice recognition environment information, the characteristics of the microphone are obtained from the input information, when the environment change score is larger than the threshold, the generation unit 33 generates the update data by applying, to the accumulated input information, a filter for conversion into the microphone characteristics corresponding to the current environment.

In addition, for example, in a case where, as the voice recognition environment information, spatial information of audio is obtained from the input information, when the environment change score is larger than the threshold, the generation unit 33 generates update data by superimposing, on the accumulated input information, data including spatial information corresponding to the current environment.

Note that, in a case of not only voice recognition but also face recognition, even in a case where only a camera image is obtained as the environment information, the generation unit 33 can generate update data for improving the performance of the face recognition by, for example, clearing blurring of a face portion or correcting a light state.

A third method is a method in which, in a case where it is determined that improvement of the personal feature model for extracting the personal feature amount is necessary, the re-registration unit 31 performs re-training (re-learning) by changing the personal feature model of the personal feature model storage unit 4 or adding training data used for re-training of the personal feature model.

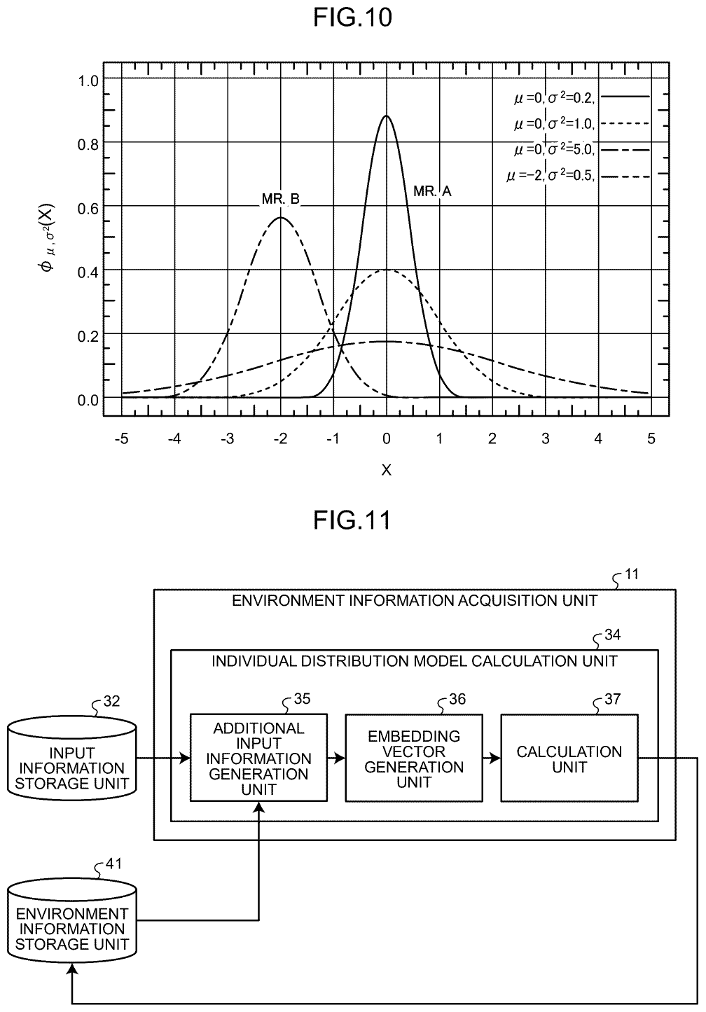

Next, a method of determining registration success/failure at the time of re-registering the person dictionary will be described. There are, for example, the following two methods for determining the registration success/failure at the time of re-registering the person dictionary.
(i) The specifying unit 7 specifies a person by using each of the plurality of pieces of input information and the updated person dictionary, and the monitoring unit 23 monitors specific accuracy. The re-registration unit 31 determines that the update succeeds if the accuracy is greater than or equal to a certain threshold.
(ii) The environment information acquisition unit 11 calculates the distribution (see FIG. 10) of the feature amount for each user from the plurality of pieces of input information by using a Gaussian distribution, a von Mises distribution, or the like. FIG. 10 is a diagram illustrating an example of an individual distribution model according to the second embodiment. If the feature amount indicated by the updated person dictionary falls within a confidence interval of the individual distribution model of FIG. 10, the re-registration unit 31 determines that the update of the person dictionary succeeds.

A functional configuration of the environment information acquisition unit 11 for determining success/failure of re-registration of the person dictionary by the determination method (ii) using the distribution will be described with reference to FIG. 11.

FIG. 11 is a diagram illustrating an example of the functional configuration of the environment information acquisition unit 11 according to the second embodiment. The environment information acquisition unit 11 according to the second embodiment includes an individual distribution model calculation unit 34 (an additional input information generation unit 35, an embedding vector generation unit 36, and a calculation unit 37).

The additional input information generation unit 35 generates additional input information from the input information of the input information storage unit 32 accumulated so far, thereby increasing (augmenting) the number of pieces of input information. For example, in a case where the person specifying function of the specifying unit 7 is a function using the speaker identification technology, the additional input information generation unit 35 generates the additional input information by superimposing a plurality of types of noise on the input information while changing the SNR. In addition, for example, the plurality of pieces of input information used for determination may include the additional input information newly generated by superimposing data including the voice recognition environment information on the input information.

In addition, for example, in a case where the speaker identification technology is a method that does not depend on a keyword, the additional input information generation unit 35 generates the additional input information by dividing the voice used for speaker information generation into several tens of milliseconds and randomly shuffling the divided voice. That is, the plurality of pieces of input information used for the determination may include the additional input information newly generated by rearranging the temporal order of the data included in the input information.

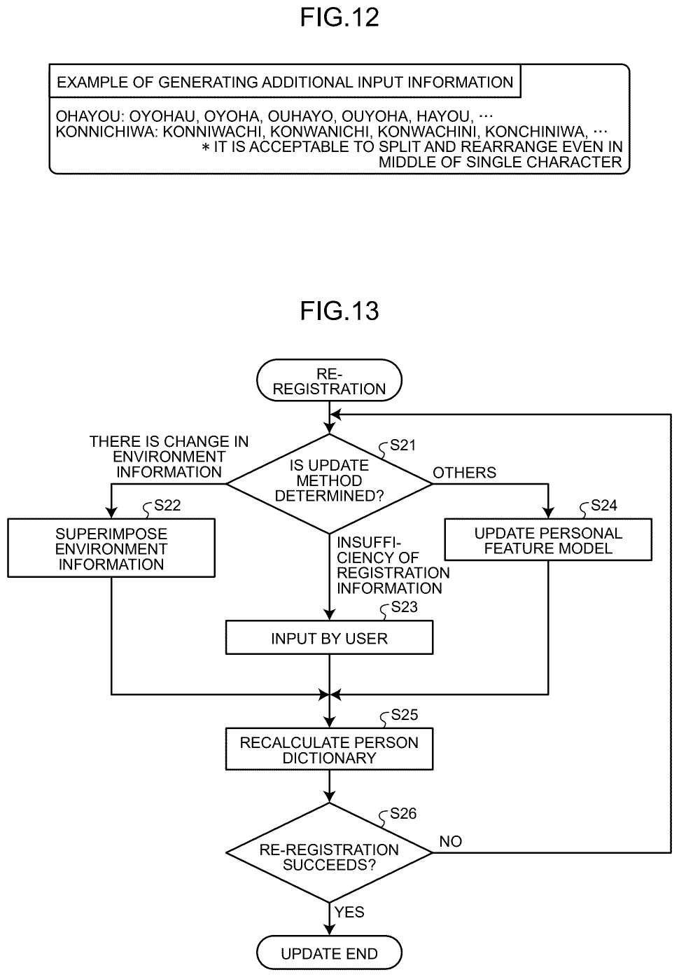

FIG. 12 is a diagram illustrating an example of generating the additional input information according to the second embodiment. As illustrated in FIG. 12, the additional input information generation unit 35 newly generates a plurality of pieces of additional input information by rearranging the temporal order of the data included in the input information. It is acceptable to split and rearrange even in the middle of a single character.

Returning to FIG. 11, the embedding vector generation unit 36 extracts a plurality of feature amounts by generating an embedding vector indicating the feature amount from each of the plurality of pieces of input information including the additional input information.

The calculation unit 37 calculates (estimates) an individual distribution model based on a multidimensional Gaussian distribution or the like from the plurality of extracted feature amounts, and stores, as one of the environment information, the individual distribution model in the environment information storage unit 41.

In a case where the above-described individual distribution model of FIG. 10 has been calculated, the individual distribution model can be used for processing of the monitoring unit 23 and the re-registration unit 31 thereafter. Specifically, when whether or not the feature amount extracted from the input information is within the confidence interval of the individual distribution model is determined each time the input information is input by the user, it is possible to determine success/failure of the person specification and success/failure of the re-registration of the person dictionary.

FIG. 13 is a flowchart illustrating a first example of a re-registration flow of the person dictionary according to the second embodiment. First, the re-registration unit 31 determines an update method (re-registration method) of the person dictionary (step S21).

When the environment change score is larger than the threshold (that is, the difference is large), the re-registration unit 31 controls re-registration processing of the person dictionary based on the current environment information. Specifically, first, for example, the generation unit 33 superimposes the current environment information on the user's input information stored in the input information storage unit 32 (step S22). Then, the registration unit 5 recalculates the person dictionary of the person dictionary storage unit 6 on the basis of the feature amount extracted by the extraction unit 3 from the input information suitable for the environment (step S25).

In addition, in a case where the registration information at the time of person registration is insufficient (for example, in a case where a total mora count or a registered word count (or a registration time) is less than a threshold), the performance may be excellent at the time of registration, but may often become poor at a later date. Therefore, for example, in a case where the registration information is insufficient, the re-registration unit 31 receives the input of the input information from the user via the input device 1, and controls the re-registration processing of the person dictionary by compensating for the insufficiency of the registration information (steps S23 and S25).

For example, in a case where the environment information includes the total mora count corresponding to the feature amount indicated by the person dictionary or the registered word count corresponding to the feature amount indicated by the person dictionary, the flows of steps S23 and S25 can be executed. That is, when the re-registration unit 31 re-registers the person dictionary, in a case where the total mora count is smaller than a mora count threshold or in a case where the registered word count is smaller than a registered word count threshold, the re-registration unit 31 performs control to re-register the person dictionary, on the basis of the voice re-input by the microphone.

In other cases (a case where there is no environment change and a case where the registration information is not insufficient), the accuracy of the person specification may be improved by updating (re-training) the personal feature model used for extraction.

For example, in the determination in step S21, as an example of the update method in other cases, an example of determining whether or not to update the personal feature model by using the above-described individual distribution model is conceivable. In this determination example, for example, in a case where the user is known in advance, the distribution of the input information of the user is obtained, and if the feature amount obtained from the current input information is out of a confidence interval of the distribution, the processing proceeds to step S24, and the personal feature model for feature extraction is updated (step S24). Then, the registration unit 5 recalculates the person dictionary of the person dictionary storage unit 6 on the basis of the feature amount extracted using the updated personal feature model (step S25).

Next, the monitoring unit 23 calculates the performance of the person specifying function by using the recalculated person dictionary and the input information accumulated in the past, and determines that the re-registration of the person dictionary succeeds if the accuracy is greater than or equal to the threshold (the performance is greater than or equal to a reference) (step S26, Yes), and the re-registration processing is ended. On the other hand, if a specific accuracy falls below the threshold, the monitoring unit 23 determines that re-registration of the person dictionary has failed (step S26, No), and the update processing returns to step S21 and continues recalculation of the person dictionary by another update method.

Note that the example of the re-registration flow of the person dictionary in FIG. 13 is merely an example, and another re-registration flow may be used.

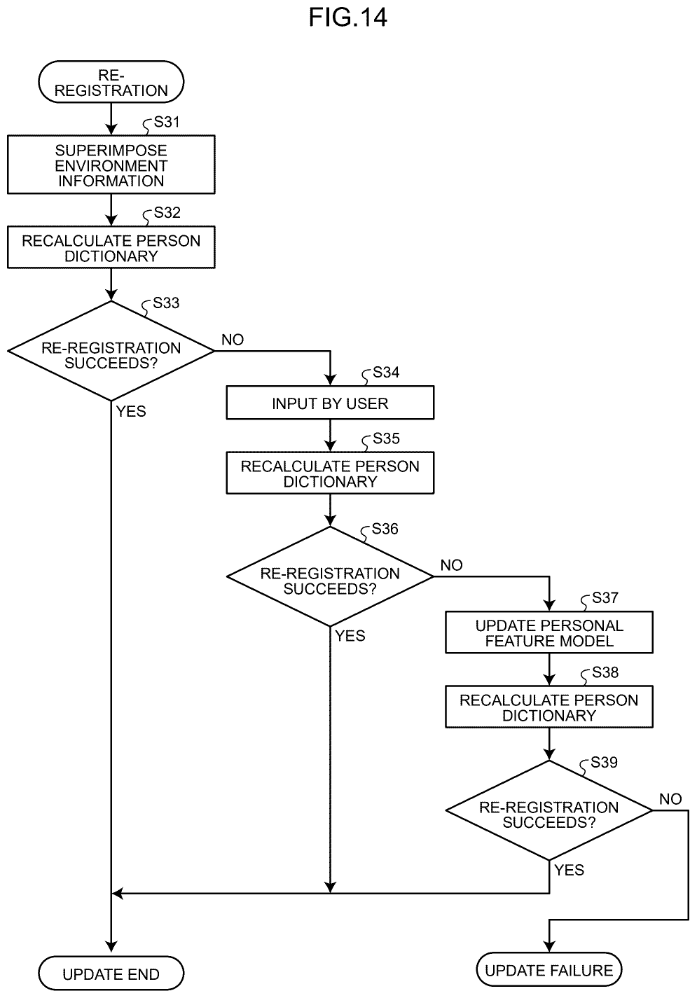

FIG. 14 is a flowchart illustrating a second example of the re-registration flow of the person dictionary according to the second embodiment (S31-S39). For example, as illustrated in FIG. 14, re-registration success may be determined (steps S33, S36, and S39), and the person dictionary may be recalculated (updated) in order until the re-registration succeeds. In the example of FIG. 14, three recalculation patterns are tried in order, and the update is considered completed when it is determined that the re-registration succeeds in any of steps S33, S36, and S39, and the update is considered failed when it is determined in step S39 that the re-registration has failed.

According to the second embodiment, only by the user selection (or user estimation) at the start of use, it is also possible to automatically update the person dictionary according to the use environment without relying on the input by the user at the time of identification failure, for example. Accordingly, it is possible to eliminate the user's effort to input the input information at each time of identification failure.

Note that, in addition to a method of overwriting the person dictionary, a method of adding a newly generated feature amount to the past person dictionary is also conceivable as the method of updating the person dictionary. In addition, a method of averaging using the feature amount indicated by the past person dictionary and the newly generated feature amount, a method of leaving both the feature amount indicated by the past person dictionary and the newly generated feature amount, or the like is also conceivable.

### Modification of Second Embodiment

Next, a modification of the second embodiment will be described. In the description of the modification, the description similar to that of the second embodiment will be omitted, and portions different from those of the second embodiment will be described. In a case where the person specifying function by the specifying unit 7 of the information processing apparatus 100-2 is used in a car, for example, noise or the like may change depending on whether or not the car is traveling, and the environment information may change frequently and greatly. In such a case, if the method according to the second embodiment remains, the re-registration of the person dictionary may occur frequently. In the second embodiment, a method of coping with such a case will be described.

In the modification, when the person dictionary used for person specification is selected, a plurality of person dictionaries corresponding to (or more than) the number of types of environments that may change frequently are selected. Then, the specifying unit 7 performs the person specification by using each of the plurality of person dictionaries, and in a case where a person is specified in one or more person dictionaries, the specifying unit 7 determines that the person has been specified.

Alternatively, in a case where the same person is specified in over half of the person dictionaries, the specifying unit 7 may determine that the person has been specified. Alternatively, instead of performing the person specification with the plurality of person dictionaries, a method may be used in which the environment information for selecting an appropriate person dictionary is acquired every certain period, and the person specification is performed by reselecting one person dictionary according to the current environment information every certain period.

### Third Embodiment

Next, a third embodiment will be described. In the description of the third embodiment, the description similar to that of the second embodiment will be omitted, and portions different from those of the second embodiment will be described. In the third embodiment, control in a case where a plurality of person dictionaries is stored for one user in the person dictionary storage unit 6 will be described.

### Example of Functional Configuration

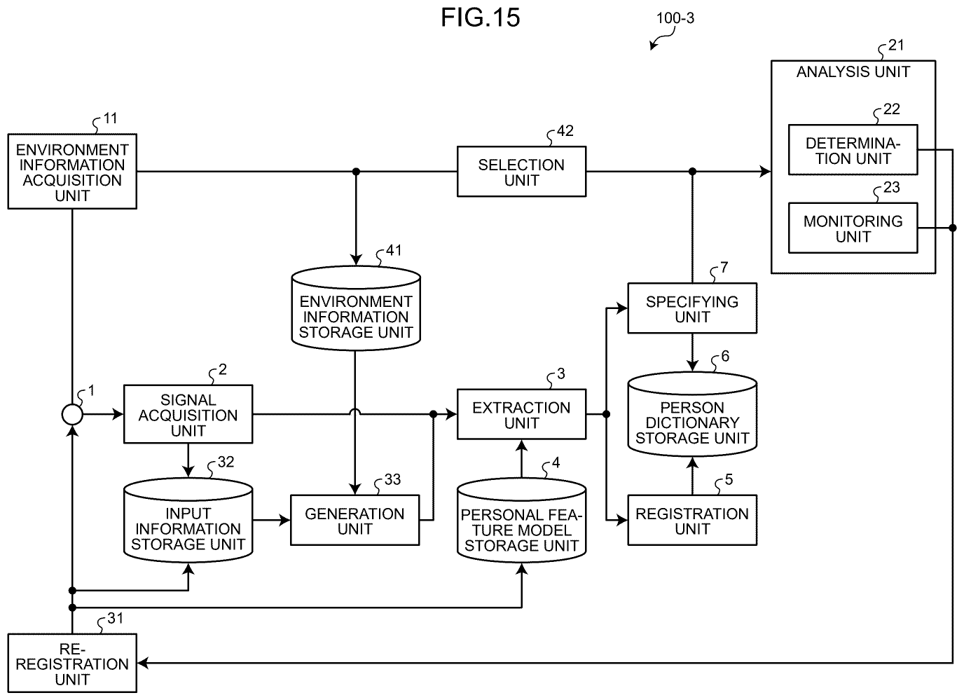

FIG. 15 is a diagram illustrating an example of a functional configuration of an information processing apparatus 100-3 according to the third embodiment. The information processing apparatus 100-3 according to the third embodiment includes the input device 1, the signal acquisition unit 2, the extraction unit 3, the personal feature model storage unit 4, the registration unit 5, the person dictionary storage unit 6, the specifying unit 7, the environment information acquisition unit 11, the analysis unit 21, the re-registration unit 31, the input information storage unit 32, the generation unit 33, the environment information storage unit 41, and a selection unit 42.

In the third embodiment, the selection unit 42 is further added to the configuration of the information processing apparatus 100-2 of the second embodiment.

In the information processing apparatus 100-3 controlled using the person specifying function by the specifying unit 7, in a case where the use environment of the information processing apparatus 100-3 frequently changes, it is conceivable that one user registers a plurality of person dictionaries corresponding to the use environment in the person dictionary storage unit 6. In a case where the information processing apparatus 100-3 is a portable laptop computer or the like, it is assumed that the use environment changes frequently.

In a case where a plurality of person dictionaries is stored for one person in the person dictionary storage unit 6, the selection unit 42 selects the person dictionary according to the environment information. Specifically, when selecting the person dictionary at the time of using the information processing apparatus 100-3, the selection unit 42 calculates the environment change score by using each of the environment information stored at the time of registering the plurality of person dictionaries and the current environment information. Then, the selection unit 42 can automatically select an appropriate person dictionary in the environment by selecting the person dictionary having the smallest environment change score. For example, only by inputting the user's identification information such as a user name to the information processing apparatus 100-3, it is possible to eliminate the user's effort to select the person dictionary by himself/herself.

### Fourth Embodiment

Next, a fourth embodiment will be described. In the description of the fourth embodiment, the description similar to that of the second embodiment will be omitted, and portions different from those of the second embodiment will be described. In a case where the accuracy monitoring of person specification is performed, even when the environment information does not change, there is a case where the accuracy decreases due to a temporal change. In the fourth embodiment, a method will be described in which a feature vector and the person dictionary are automatically updated according to the temporal change in such a case.

### Example of Functional Configuration

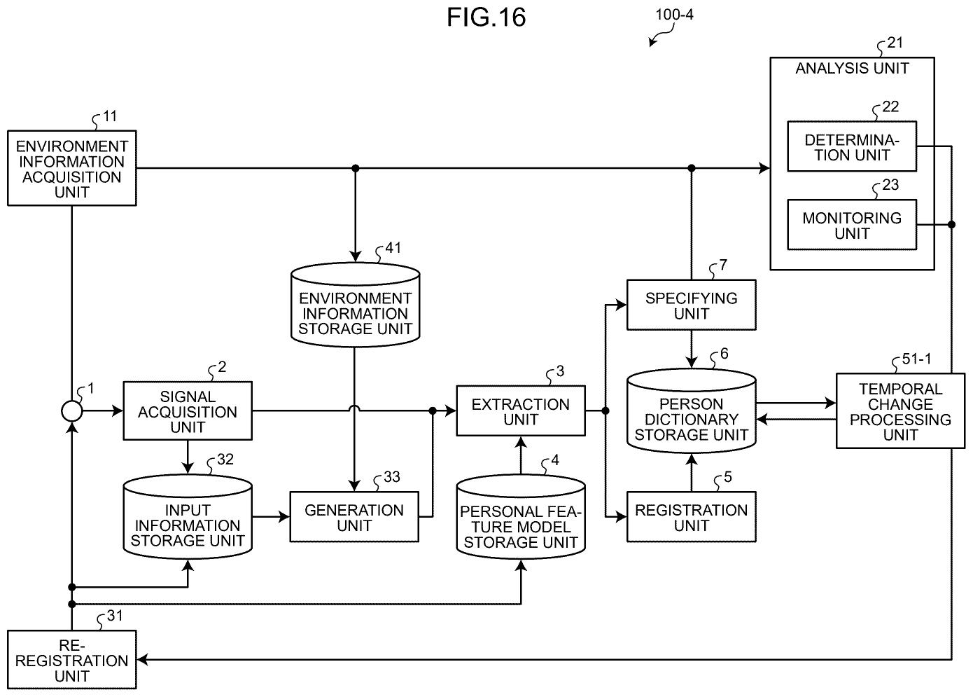

FIG. 16 is a diagram illustrating an example of a functional configuration of an information processing apparatus 100-4 according to the fourth embodiment. The information processing apparatus 100-4 according to the fourth embodiment includes the input device 1, the signal acquisition unit 2, the extraction unit 3, the personal feature model storage unit 4, the registration unit 5, the person dictionary storage unit 6, the specifying unit 7, the environment information acquisition unit 11, the analysis unit 21, the re-registration unit 31, the input information storage unit 32, the generation unit 33, the environment information storage unit 41, and a temporal change processing unit 51-1.

In the fourth embodiment, the temporal change processing unit 51-1 is further added to the configuration of the information processing apparatus 100-2 of the second embodiment.

For example, by calculating the transition of the change in the personal feature amount from the input information accumulated in the input information storage unit 32, the temporal change processing unit 51-1 processes the temporal change of the feature amount indicated by the person dictionary of the person. Then, the re-registration unit 31 performs control to re-register the person dictionary of the person on the basis of the feature amount after the temporal change.

In addition, for example, the temporal change processing unit 51-1 automatically changes the speaker vector over time by leaving a record in which the person dictionary (speaker vector) is updated for each person and analyzing how the speaker vector changes with the temporal change.

Specifically, in the fourth embodiment, at the time of registering the person dictionary, the registration unit 5 stores, as the environment information of the person dictionary, the environment information including the registration date in the environment information storage unit 41. Then, the temporal change processing unit 51-1 analyzes how the speaker vector changes with the temporal change by using, for example, a method of training an estimation model that estimates a current speaker vector from past speaker vectors in a long short-term memory (LSTM) or the like for each user. For example, this estimation model is trained as an estimation model that inputs, to the LSTM, the last n person dictionaries (speaker vectors) in the past among the person dictionaries having the same environment information and outputs the (n+1)-th person dictionary (speaker vector).

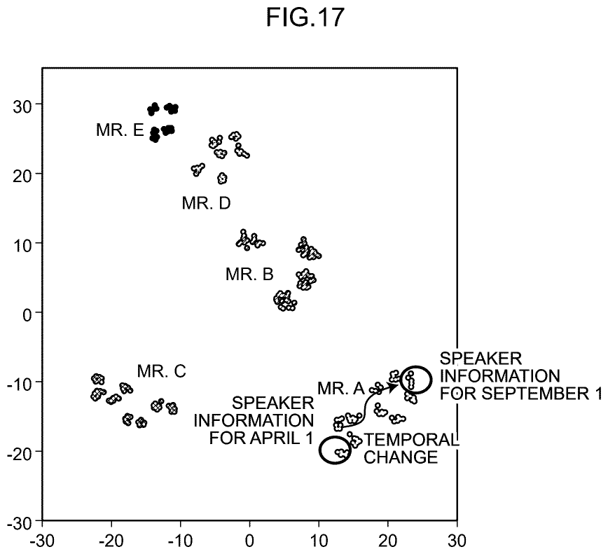

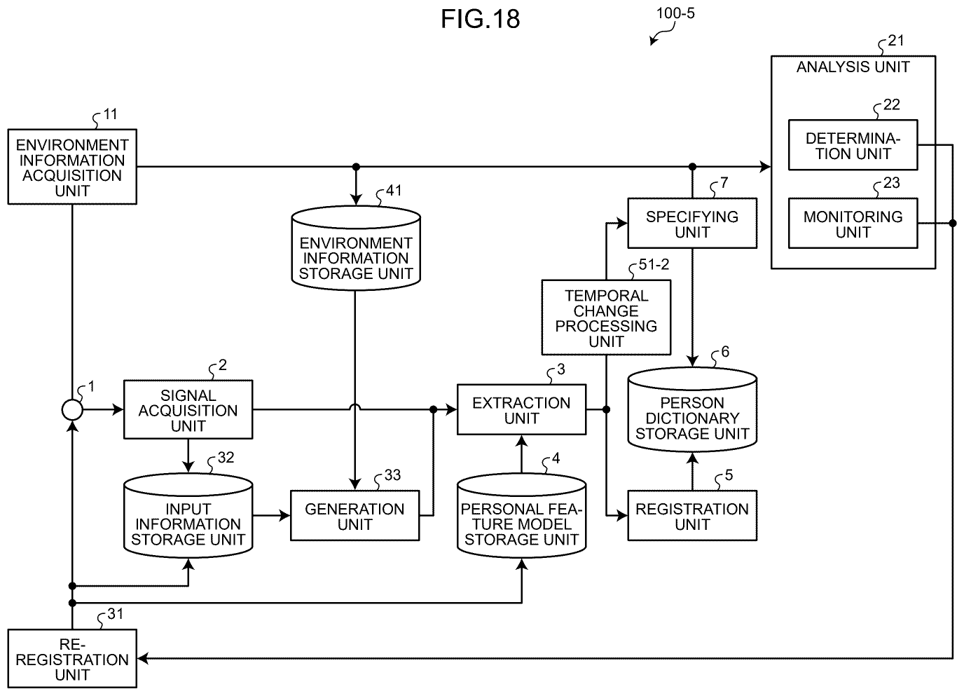

FIG. 17 is a diagram illustrating a processing example of the temporal change processing unit 51-1 according to the fourth embodiment. In the example of FIG. 17, an example of temporal change processing of the speaker information (speaker vector) of Mr. A is illustrated.

### Modification of Fourth Embodiment

Next, a modification of the fourth embodiment will be described. In the description of the modification, the description similar to that of the fourth embodiment will be omitted, and portions different from those of the fourth embodiment will be described.

### Example of Functional Configuration

FIG. 16 is a diagram illustrating an example of a functional configuration of an information processing apparatus 100-5 according to the modification of the fourth embodiment. The information processing apparatus 100-5 according to the modification includes the input device 1, the signal acquisition unit 2, the extraction unit 3, the personal feature model storage unit 4, the registration unit 5, the person dictionary storage unit 6, the specifying unit 7, the environment information acquisition unit 11, the analysis unit 21, the re-registration unit 31, the input information storage unit 32, the generation unit 33, the environment information storage unit 41, and a temporal change processing unit 51-2.

In the modification, the temporal change processing unit 51-1 of the fourth embodiment is changed to the temporal change processing unit 51-2 added between the extraction unit 3 and the specifying unit 7. The modification is different from the fourth embodiment in that the temporal change processing unit 51-2 performs processing of considering an influence of a temporal change of a person not on the person dictionary (speaker vector) but on the feature amount compared with the person dictionary.

The same effects as those of the fourth embodiment can be obtained by the configuration of the modification of the fourth embodiment.

Finally, an example of a hardware configuration of the information processing apparatus 100 (100-2, 100-3, 100-4) of the first to fourth embodiments and the information processing apparatus 100-5 of the modification will be described.

### Example of Hardware Configuration

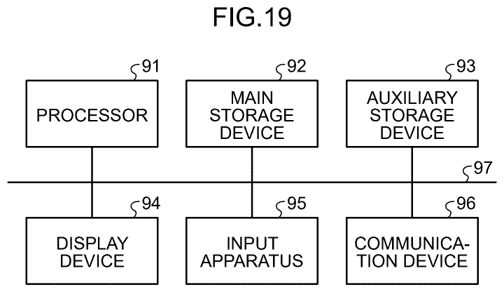

FIG. 19 is a diagram illustrating an example of a hardware configuration of the information processing apparatus 100 (100-2, 100-3, 100-4) according to the first to fourth embodiments and the information processing apparatus 100-5 according to the modification. The information processing apparatus 100 (100-2 to 100-5) includes a processor 91, a main storage device 92, an auxiliary storage device 93, a display device 94, an input apparatus 95, and a communication device 96. The processor 91, the main storage device 92, the auxiliary storage device 93, the display device 94, the input apparatus 95, and the communication device 96 are connected via a bus 97.

Note that the information processing apparatus 100 (100-2 to 100-5) may not include a part of the above configuration. For example, in a case where the information processing apparatus 100 (100-2 to 100-5) can use an input function and a display function of an external apparatus, the information processing apparatus 100 (100-2 to 100-5) may not include the display device 94 and the input apparatus 95.

The processor 91 executes a program read from the auxiliary storage device 93 to the main storage device 92. The main storage device 92 is a memory such as a ROM and a RAM. The auxiliary storage device 93 is a hard disk drive (HDD), a memory card, or the like.

The display device 94 is, for example, a liquid crystal display or the like. The input apparatus 95 corresponds to one or more of the input devices 1 described above. The communication device 96 is an interface for communicating with another device.

In addition, for example, the configuration may also be made such that the program executed by the information processing apparatus 100 (100-2 to 100-5) is stored on a computer connected to a network such as the Internet and provided by being downloaded via the network.

In addition, for example, the configuration may also be made such that the program executed by the information processing apparatus 100 (100-2 to 100-5) is provided via a network such as the Internet without being downloaded. Specifically, the configuration may also be made such that the information processing is executed by a so-called application service provider (ASP) type service in which the program is not transferred from a server computer and a processing function is implemented only by an execution instruction and result acquisition.

In addition, for example, the configuration may also be made such that the program of the information processing apparatus 100 (100-2 to 100-5) is provided by being incorporated in a ROM or the like in advance.

The program executed by the information processing apparatus 100 (100-2 to 100-5) has a module configuration including functions that can be implemented by the program among the above-described functional configurations. In actual hardware, each of the functions is loaded onto the main storage device 92 as each functional block described above when the processor 91 reads programs from a storage medium and executes them. That is, the functional blocks are generated on the main storage device 92.

Note that some or all of the above-described functions may not be implemented by software but may be implemented by hardware such as an IC.

In addition, each function may be implemented using a plurality of processors 91, and in this case, each processor 91 may implement one of the functions or may realize two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more input devices that acquire input information; and
one or more hardware processors configured to function as:
an extraction unit that extracts a feature amount indicating a feature of a person from the input information by using a personal feature model;
a specifying unit that specifies the person by comparing the feature amount with a feature amount indicated by a person dictionary;
an environment information acquisition unit that acquires environment information from the input information;
an analysis unit that analyzes a change in the environment information and specifying accuracy of the person by the specifying unit; and
a re-registration unit that performs control to re-register the person dictionary in a case where there is a change in the environment information or in a case where the specifying accuracy is less than an accuracy threshold.

2. The information processing apparatus according to claim 1, wherein
in a case where the environment information is time-series data, when a part of data indicating the environment information is not acquirable, the environment information acquisition unit infers the environment information by interpolating the part of data from acquired partial data of the environment information.

3. The information processing apparatus according to claim 1, wherein
the analysis unit calculates an environment change score indicating a magnitude of a change in the environment information, and
in a case where the environment change score is larger than a change threshold, the re-registration unit performs control to re-register the person dictionary.

4. The information processing apparatus according to claim 3, wherein
the one or more input devices include a microphone;
the information processing apparatus further comprises:
a person dictionary storage unit that stores the person dictionary therein,
an environment information storage unit that stores the environment information therein, and
an input information storage unit that accumulates the input information therein;
the environment information includes voice recognition environment information obtained from input information input by the microphone;
the information processing apparatus further comprises: a generation unit that generates update data by superimposing data including the voice recognition environment information on accumulated input information in a case where the environment change score is larger than the change threshold; and
the re-registration unit executes first re-registration processing of re-registering the person dictionary, on a basis of the update data.

5. The information processing apparatus according to claim 4, wherein
the environment information stored in the environment information storage unit further includes a total mora count corresponding to a feature amount indicated by the person dictionary or a registered word count corresponding to the feature amount indicated by the person dictionary, and
when the re-registration unit re-registers the person dictionary, in a case where the total mora count is smaller than a mora count threshold or in a case where the registered word count is smaller than a registered word count threshold, the re-registration unit executes second re-registration processing of re-registering the person dictionary, on a basis of a voice re-input by the microphone.

6. The information processing apparatus according to claim 5, wherein
when the re-registration unit re-registers the person dictionary, in a case where the environment change score is less than the change threshold, the total mora count is greater than or equal to the mora count threshold, and the registered word count is greater than or equal to the registered word count threshold, the re-registration unit executes third re-registration processing of updating the personal feature model, by re-training the personal feature model.

7. The information processing apparatus according to claim 6, wherein
after the re-registration unit re-registers the person dictionary, in a case where the specifying accuracy is larger than an accuracy threshold or in a case where a feature amount indicated by the re-registered person dictionary falls within a confidence interval of distribution of a feature amount of the person calculated by using a plurality of pieces of input information, the re-registration unit ends re-registration processing.

8. The information processing apparatus according to claim 7, wherein
the plurality of pieces of input information includes additional input information newly generated by superimposing data including the voice recognition environment information on the input information.

9. The information processing apparatus according to claim 7, wherein
the plurality of pieces of input information includes additional input information newly generated by rearranging a temporal order of data included in the input information.

10. The information processing apparatus according to claim 4, wherein
the one or more hardware processors are configured to further function as:
a selection unit that selects the person dictionary according to the environment information in a case where a plurality of person dictionaries is stored for one person in the person dictionary storage unit.

11. The information processing apparatus according to claim 4, wherein
the one or more hardware processors are configured to further function as:
a temporal change processing unit that processes a temporal change in a feature amount indicated by the person dictionary of the person by calculating a transition of a change in a feature amount of the person from the input information accumulated in the input information storage unit, and
the re-registration unit performs control to re-register the person dictionary of the person, on a basis of a feature amount after the temporal change.

12. The information processing apparatus according to claim 4, wherein
the environment information further includes a frequency characteristic of the microphone.

13. The information processing apparatus according to claim 1, wherein
the one or more input devices include a receiver that receives input of global positioning system (GPS) information,
the environment information further includes position information of the information processing apparatus based on the GPS information, and
when a part of data indicating the environment information is not acquirable, the environment information acquisition unit infers position information indicated by the part of data from the position information and a moving speed of the information processing apparatus and infers environment information indicated by the part of data that is not acquirable, from the inferred position information.

14. The information processing apparatus according to claim 1, wherein
the one or more input devices include a camera that acquires a captured image, and
the environment information includes at least one of a captured image including the person and iris information of the person.

15. The information processing apparatus according to claim 1, wherein
the one or more input devices include a sensor that acquires a fingerprint of the person, and
the environment information includes information indicating the fingerprint of the person.

16. The information processing apparatus according to claim 1, wherein
the one or more input devices include a device that receives an operation input indicating at least one of a gender of the person and an age of the person, and
the environment information includes at least one of the gender of the person and the age of the person.

17. An information processing method implemented by a computer of an information processing apparatus, the method comprising:
acquiring input information;
extracting a feature amount indicating a feature of a person from the input information by using a personal feature model;
specifying the person by comparing the feature amount with a feature amount indicated by a person dictionary;
acquiring environment information from the input information;
analyzing a change in the environment information and specifying accuracy of the person by the step of specifying; and
performing control to re-register the person dictionary in a case where there is a change in the environment information or in a case where the specifying accuracy is less than an accuracy threshold.

18. A computer program product having a non-transitory computer readable medium including instructions stored thereon, wherein the instructions, when executed by a computer with one or more input devices acquiring input information, cause the computer to function as:
an extraction unit that extracts a feature amount indicating a feature of a person from the input information by using a personal feature model;
a specifying unit that specifies the person by comparing the feature amount with a feature amount indicated by a person dictionary;
an environment information acquisition unit that acquires environment information from the input information;
an analysis unit that analyzes a change in the environment information and specifying accuracy of the person by the specifying unit; and
a re-registration unit that performs control to re-register the person dictionary in a case where there is a change in the environment information or in a case where the specifying accuracy is less than an accuracy threshold.
